(19) United States
(12) Patent Application Publication
(10) Pub. No.: US 2016/0154841 A1
(43) Pub. Date: Jun. 2, 2016

(54) METHODS AND APPARATUS FOR ADMINISTERING A MUTUALLY OWNED SECURE EMAIL AND FILE REPOSITORY FOR FAMILY MEMBERS

(71) Applicant: William D. Meadow, Jacksonville, FL (US)

(72) Inventor: William D. Meadow, Jacksonville, FL (US)

(21) Appl. No.: 14/950,719

(22) Filed: Nov. 24, 2015

Related U.S. Application Data
(60) Provisional application No. 62/085,264, filed on Nov. 27, 2014.

(51) Int. Cl. G06F 17/30; H04L 29/08; H04L 12/58

(52) U.S. Cl. CPC G06F 17/30371; H04L 51/046; H04L 67/1097

(57) ABSTRACT

The present invention provides apparatus for allocating assets and services based upon investment a mutual company with a common asset infrastructure and individual assets, wherein purchase of equity rights in a Family Storage Vault mutual company or other Entity Unit Storage Vault provides the Investor/Purchaser with ownership rights in assets of the mutual and a right to receive document storage rights and email services offered by the mutual company.

### CROSS REFERENCE TO RELATED APPLICATIONS

The present application claims priority to Provisional Patent Application Ser. No. 62/083,856, filed, Nov. 24, 2014 and entitled, “METHODS AND APPARATUS FOR SHARED OWNERSHIP TRANSACTIONAL ASSET BACKED SECURITY” as a continuation in part application, the contents of which are relied upon and incorporated by reference; and to Provisional Patent Application Ser. No. 62/085,264, filed, Nov. 27, 2014 and entitled, “METHODS AND APPARATUS FOR ADMINISTERING A MUTUALLY OWNED SECURE EMAIL AND FILE REPOSITORY FOR FAMILY MEMBERS,” the contents of which are relied upon and incorporated by reference.

### BACKGROUND OF THE INVENTION

The present invention includes computerized methods and apparatus for facilitating and brokering investment in a company via a service provision infrastructure, wherein purchase of a service provided by the company entitles the purchaser to an equity share in the company. The purchase of the share will also grant the purchaser predefined rights of company ownership.

Currently, it is commonplace families to keep important records in a “safe place” that is often misplaced or forgotten. Generally, a family matriarch or patriarch is tasked with maintaining such records, and few are adequately skilled to organize and store the increasingly large plethora of electronic documents. As a result, many electronic documents and other records are misplaced or at least difficult to locate.

Currently, it is commonplace families to keep important paper documents, electronic records, photos, heirlooms and other important items to the family in a safe place where over a period of years, they often become misplaced, damaged, electronically inaccessible or forgotten. Generally, a parent or grandparent is entrusted with and deeply wants to maintain such records, and few are adequately skilled to organize and store the increasingly large set of diverse electronic and paper documents from various sources as well as various family heirlooms. As a result, many paper documents and other electronic records are misplaced, difficult to locate and access electronically.

As Family Members grow more mobile and live in multiple disparate locations in the course of a lifetime, the issue of maintaining family records is exacerbated. For example, until the last two generations, Family Members generally lived in or around a single county for multiple generations. A physical location for storing important documents would be known by Family Members and accessible within a short travel distance to access. The amount of relevant documents was relatively small and did not require much organization,

Today, with the Internet available to nearly every person on earth, there are numerous email and cloud file management systems that enable individual users to store emails, attachments and files of any type on-line. In addition, the user may make available any set of folders and files to friends, relatives, colleagues and vendors. However, the rules by which they enable the sharing is not established automatically.

End user consumer applications provide simple procedures for naming and utilizing “Defined Folders” to store documents and email attachments are well known. End user consumer applications additionally provide procedures for creating “User Groups” with email systems and document access systems are well known.

Rules for “Provisioning Users” with various network access rights are well phone. In many cases a flat file with names, numbers, access rights and other fields of data can be imported as a flat CSV file to generate large numbers of accounts automatically.

Today, Family Members are spread across multiple cities and time zones, and often in different countries. Understanding where family related documents are located and how they are organized and accessed has become very difficult to manage. In addition, the number and diversity of electronic document formats and digital image formats necessary for Family Members to track has increased significantly in the Internet Age. Health records, legal documents, identification documents, as well as commercial documents, such as deeds, licenses, mortgage documents, warranties, receipts as well as social media data and various forms of communication must all be available in today's world, but no single vehicle is available to make such information available in a convenient, accessible and secure fashion for all Family Members over time.

In another aspect, a mutual company may be a private company whose ownership base is made of its clients, members or policyholders. Currently, credit unions or mutual insurance companies are the primary industries that allow this cooperative benefit. A credit union is a member-owned financial cooperative, democratically controlled by its members, and operated for the purpose of promoting thrift, providing credit at competitive rates, and providing other financial services to its members. A mutual exists with the purpose of raising funds from its membership and using such funds to provide common services to all members of the organization or society. A mutual is therefore owned by, and purposed for the benefit of the mutual members. They exist for the members to benefit from the services the Mutual provides.

What is needed is an apparatus that will conveniently receiver, organize, provision, secure, and archive Family Docs and heirlooms by importing and then making paper and electronic records available from a variety of government, commercial, personal and Internet based sources on a worldwide basis that meets the needs of families desire to conveniently provision and maintain long term complete access of their personal and private electronic records and heirlooms in formats and structures that can automatically support the various technology changes of industries as well as families go through as children are raised, move out and get married and navigate many life events pleasant and un pleasant while maintaining the comfort in knowing that the apparatus will be there carrying out its duties for generations to come.

### SUMMARY

Accordingly, the present invention provides apparatus and methods for allocating assets of a mutual company a common asset infrastructure and individual assets, wherein purchase of equity rights in a Family Storage Vault mutual company provides the Investor/Purchaser with ownership rights in physical storage device assets and a right to receive document storage rights and email services offered by the mutual company.

By way of example, a Mutual Company will provision a Family Storage Vault where the Family Members will own the physical portion (a set of partitions) of the hard drives that may be in various data centers around the world where their proprietary and private Family Designated Folders data is stored. The Family will own their Family Storage Vault as well as a portion of the COmmon Assets (COAS) that are used to operate the network infrastructure.

As described in a separate patent filing by the same named inventor, a secure Family Storage Vault may be made available via a distributed communications network. A user may access the Family Storage Vault (“FSV”) via logical communication across a distributed communications network, such as the internet.

The details of one or more embodiments of the invention are set forth in the accompanying drawings and the description below. Implementations may provide advantages such as supplemented funding for students attending a learning institution or supplemented funding of principals involved in a business venture. Other features, objects, and advantages of the invention will be apparent from the description, the drawings and the claims.

### DESCRIPTION OF THE DRAWINGS

The foregoing and other features and advantages of the invention will be apparent from the following, more particular description of preferred embodiments of the invention, as illustrated in the accompanying drawings.

FIG. 1 illustrates a block network diagram with some components that may be utilized to implement some embodiments of the present invention.

FIG. 2A illustrates a high level block diagram with exemplary entities that may be involved in implementations of the present invention including a Family Storage Vault.

FIG. 2B illustrates a detailed diagram with exemplary entities that may be involved in some implementations of the present invention.

FIG. 3 illustrates basic components of an apparatus that may be used in some embodiments of the present invention.

FIG. 4 illustrates additional aspects of apparatus that may be used in some implementations of the present invention.

FIG. 5 illustrates examples of physical assets including digital storage devices that may be allocated by a mutual company.

### DETAILED DESCRIPTION

The present invention includes apparatus and methods for allocating assets of a mutual company that provides file storage apparatus and email file storage service to investor customers, wherein an acquisition of an interest in the mutual company also grants the acquiring person predefined rights to one or both of a file storage service and email management based upon criteria such as quantity of storage and amount of data transferred. An interest may include an equity interest, a convertible note, a bond, or other interest defined by a financial instrument.

According to the present invention, computerized apparatus tracks physical assets owned by a mutual company and also private assets owned by Investor/Purchaser equity owners of the mutual company and coordinates the provision of services by the mutual to the Investor/Purchasers. In some examples of the present invention, a company may not provide a separate opportunity to purchase one or both of the email and file storage services or an equity share as a member of the mutual company. In such exemplary companies, a valuation of the company may be based, at least in part, on the price of the service provided and a number of service agreements generated as a result of shares in a company being sold. This valuation method may be particularly useful for young companies that may not have an extensive history to prove their value utilizing more traditional methods.

Generally, investment by an Investor/Purchaser may provide the Customer with rights to securitized assets utilized in the business of providing email and file storage and managed by a mutual in combination with a right to use such assets. In some embodiments, proprietary rights and physical possession of assets may be transferred to a customer based upon investment in the entity. In one aspect, the present invention may include the creation of a “Recognized Legal Entity” RELE such as a Mutual, Partnership, Corporation, Limited Liability Company (LLC) or other entity recognized by a state or other governing authority wherein a defined set of assets or an entire set of assets owned or controlled by the RELE can be “associated” according to individual “Customer” investors who will own their “CUstomer PRoprietary ASsets” (CUPRAS) while at the same time the customer will have rights to use the COmmon ASsets (COAS).

In some aspects, at least some funds gained from the Investor Purchasers may be held in investments, such as for example, low risk investments. The investments may allow for steady growth that may increase or confirm the valuation of the company.

In another aspect, a portion of the funds may be used to maintain the COAS, such as digital storage devices and provide file storage and email storage services connected to the common asset. In still further embodiments, the system may require periodic maintenance fees from Investor Purchasers, which may mitigate some of the risk of loss due to maintenance, particularly large technical issues that may cause the company to incur irregularly high expenses. In some embodiments, an Investor Purchaser may purchase units by agreeing to pay a periodic amount for a specified period. Period payments may reduce the risk of an inflated initial valuation.

Generally, an incentive is provided to individual or entity to invest in a company when such investing in the company grants a right to receive a service in addition to traditional investment rights.

In some embodiments, the computerized method and apparatus may separately recognize rights of company ownership and rights of COAS ownership. Such distinction may allow the system to utilize separate and/or unique interfacing with an Investor Purchaser as a purchaser of a service as compared to the Investor Purchaser as an investor. In some exemplary embodiments, separate interfaces may clarify whether a system communication relates to the investing aspect or a service aspect.

In some exemplary embodiments, the common asset may comprise a secure data storage space and service. Ownership of the storage space may allow an Investor Purchaser to protect their proprietary files from third party access, which may include, for example, private companies or government agencies.

In some embodiments, agreements for service may be correlated to shares of the company, wherein percent ownership of the company may be determined, at least in part, by a number of service agreements.

The present invention provides for automated services related to Family Storage Vault and methods and apparatus for providing such service. Automated apparatus define a relationship between “family” members and provide a secure storage vault for mutual access of stored data based upon the defined relationship. A communications network may be used to receive and retrieve data from any location from which the communications network may be accessed with a network access device. Stored data may include data that is accessible to one or more family members.

### GLOSSARY

“Auto Load” as used herein means automatically storing data in a predetermined storage designation based upon a security quality of a submitter of the data and a type of data i.e. attachment or data stream.

“Access Color” a visual color indicator associated with a submission or email based upon a security designation.

“Bits” as used herein means any information or artifact that may be stored as electronic or digital data. Examples of Bits may include, but is not limited to: emails, files, database entries, scanned physical records, audio files, video files, and image files, etc.

“Blending” as used herein means association of an attachment to an email (or other submission to an account) to multiple vault accounts based upon the inclusion of multiple email addresses (or other unique identifiers) with the submission.

“Defined Familial Relationship” as used herein means a relationship defined to a provider of a Family Storage Vault indicating members of a family and a nature of a relationship between two or more family members.

“Designated Folder” a storage designation, such as a file directory, where data is automatically stored based upon rules associated with a Family Vault.

“Entity Unit Member” as used herein means two or more persons that associate themselves as an Entity Unit.

“Entity Unit Member Surrogate” as used herein means a person authorized by a governing agency to act on behalf of an Entity Unit Member. In some examples of the present invention, an Entity Unit Member Surrogate may be contingent upon a set of conditions that must be met, such as, a capacity and/or availability of the Entity Unit Member.

“Entity Unit Storage Vault” as used herein means a digital storage medium in logical communication with a communications network capable of transmitting digital data to and from the digital storage medium, wherein the digital storage medium receives, stores and accesses and transmits stored digital data based upon defined relationships between two or more Entity Unit Members.

“Entity Unit” as used herein means a user defined set of individuals, in some examples of the present invention, an Entity Unit may be defined based upon one or more of: a corporate relationship, a declared partnership, a company or other government designation for a legal entity.

“First Family Member” as used herein means a person that created an associated Family Vault Account”

“Family Base Account” as used herein means an account that is automatically generated when a new individual account is formed and associated with a first defined family member of a new uniquely defined family. In some examples, the account is permanent and ownership and access may be transferred to other family members, such as children and siblings or “shirt tail relatives” if no other closer related person is identified or willing to assume the responsibility.

“Family Member” as used herein means two or more persons that associate themselves as a Family Unit.

“Family Member Surrogate” as used herein means a person authorized by a governing agency to act on behalf of a Family Member. In some examples of the present invention, a Family Member Surrogate may be contingent upon a set of conditions that must be met, such as, a capacity and/or availability of the Family Member.

“Family Storage Vault” as used herein means a digital storage medium in logical communication with a communications network capable of transmitting digital data to and from the digital storage medium, wherein the digital storage medium receives, stores and accesses and transmits stored digital data based upon defined relationships between two or more Family Members.

“Family Unit” as used herein means a user defined set of individuals, in some examples of the present invention, a Family Unit may be defined based upon one or more of: a marriage relationship, cohabitation of a shared residence, a declared engagement, a domestic partner, a civil union, a common law marriage spouse, a legal guardianship or other government designation, a government designated head of Household, a facility administrator where one or more persons are under care of an unrelated designee.

“Head of Household” as used herein means one or more persons designated to manage other family member accounts as well as the Family Account.

“Investor Purchaser(s)” as used herein means one or more legal persons who invest in a company by purchasing a service of the company and being awarded an interest in the company and the provided service as a result of the purchase.

“Mutual Company” as used herein means a private company whose ownership base is comprised of its customers of a product and/r service. As its customers are also its owners, the mutual company's customers are entitled to receive profits or income generated by the mutual company.

“Person” as used herein means any entity that meets the legal guidelines for a person within a governing jurisdiction. Examples of person therefore include a citizen of a state, a corporate entity as defined by a state and any other recognizable legal entity.

“Spawn Bits” as used herein means the act of replicating contents of a Family Vault for a Family Member, such as a child, creating their own head of household account, wherein copies of portions of contents of a first FSV may be delivered to a second FSV. In some embodiments, updated copies of contents of the first FSV may be periodically copied to the second FSV owned by a separate Investor/Purchaser than the first investor/Purchaser.

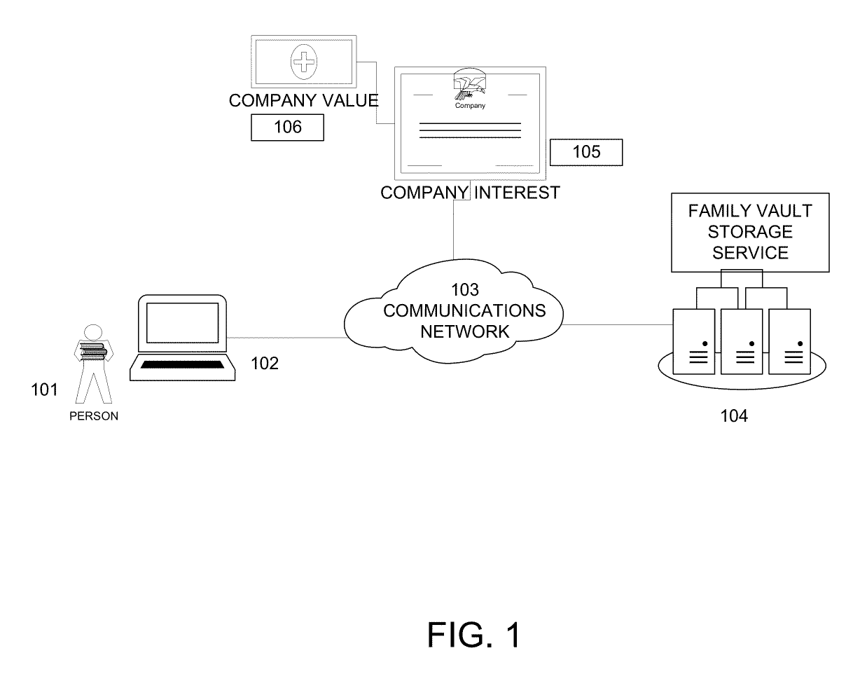

Referring now to FIG. 1, a block diagram of some facets of the present invention. Generally, a legal person 101 accesses a Family Storage Vault 104 by using a network access device communicating across a distributed communication network 103, as discussed further below. The person 101 enters into an agreement to purchase Company Interest 105, or some other interest in the company. Based upon the ownership of the Company Interest 105, the Person 101 becomes eligible to receive one or more services offered by the company, such as, for example, access to a Family Storage Vault service 104. A Company Interest 105 may include a capital instruments which would convert, under certain circumstances, into an equity type claim on the mutual called a Mutual Equity Interest (MEI).

Embodiments of the present invention include a Company Interest 105 that may be bought and sold via an exchange, such as a financial exchange. Embodiments may also include an interactive website that allows a Person 101 to access the website and purchase a Company Interest 105. Purchase, or other form of acquisition thereby entitles the owner of the Company Interest 105 to the Family Storage Vault service 104.

The entitlement of the Family Storage Vault Service 104 provides an added incentive for a Person 101 to purchase, or otherwise acquire a Company Interest 105 which includes CUPRAS and COAS, and thereby become a Purchaser/Investor. The increased incentive to purchase the Company Interest 105 and the provision of the Family Storage Vault Service 104 thereby also facilitates a manageable Company Value 106 since the Company Value 106 is tied to the value of the Family Storage Vault service. An increase in the value of the Family Storage Vault service 104 may drive an increase in the Company Value 106. Accordingly, a Company Value may be managed by an increase or a decrease in services provided to an investor/purchaser person 101.

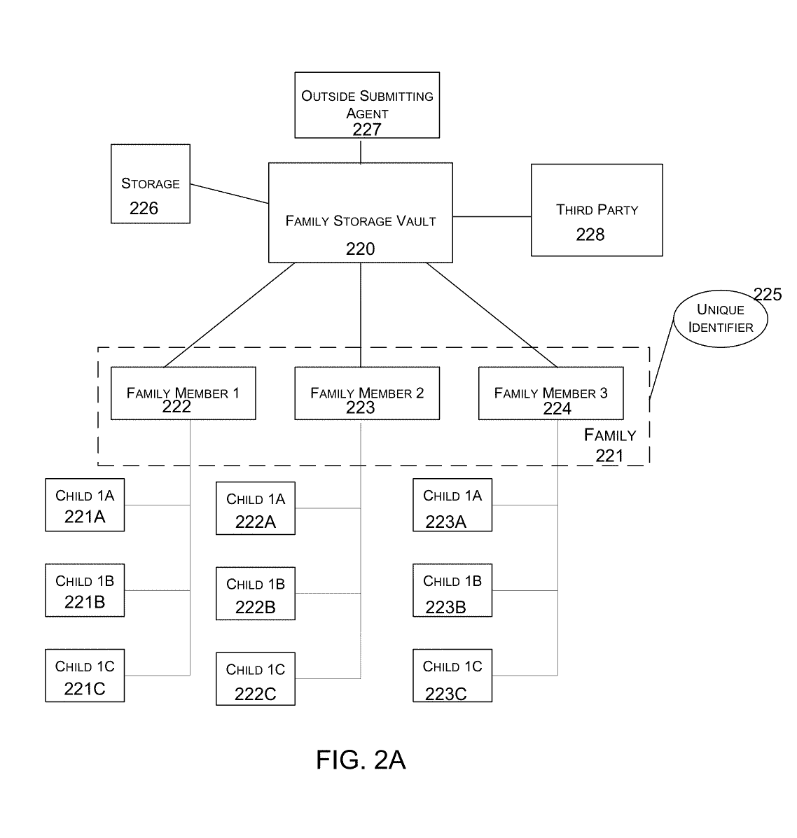

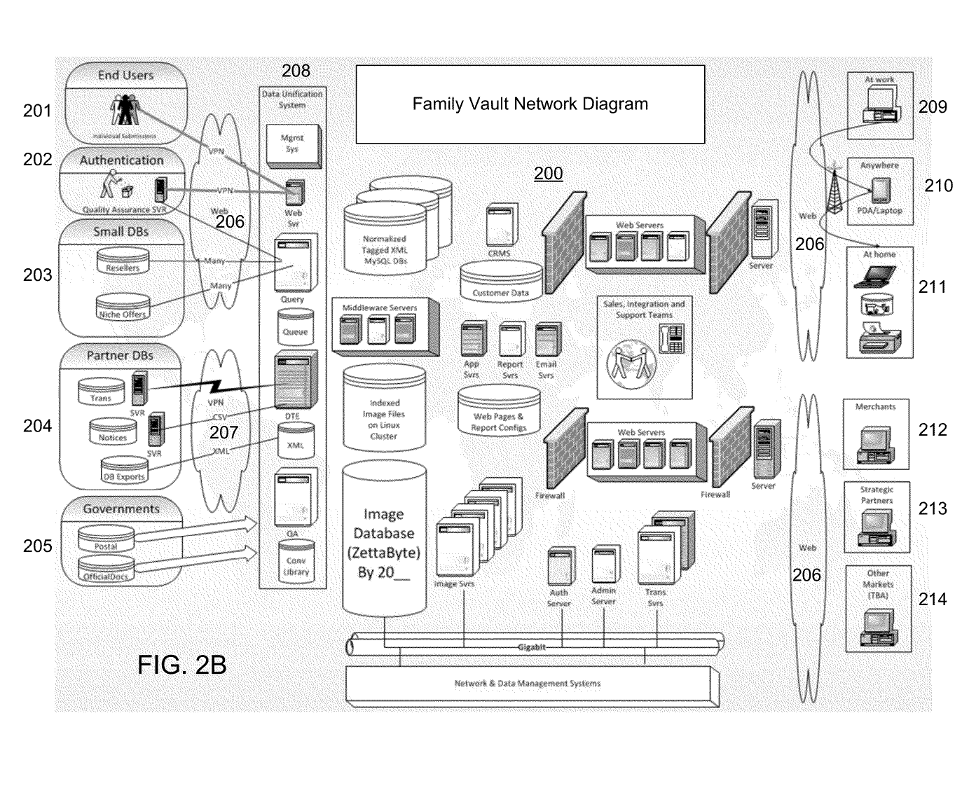

Referring now to FIG. 2A, a block diagram illustrates various components that may be used to implement embodiments of the present invention. As defined further below, a Family Storage Vault 220 includes a digital storage medium 226 accessible via a communications network. The Family Storage Vault 220 is controlled via an automated processor, in logical communication with, or incorporated into the Family Storage Vault 22 that receives and stores data associated with a Family 221 with at least two Defined Family Relationships 222-224. The Family Storage Vault 220 includes a defined relationship between two or more Defined Family Relationships 222-224. The defined relationship is referenced to provide access to disparate portions of information stored in the Family Storage Vault 220.

In some embodiments, a Family 221 is associated with a Unique Identifier 225, the Unique Identifier may include almost any manner of uniquely identifying the Family 221. Specific examples of Unique Identifiers may include a Family location in combination with, or otherwise associated with; a time period (such as, for example, a street address or town during specified years and months); a Family patriarch or matriarch identifying number, such as a Social Security Number, a military ID number, an employee number or other number; a telephone number and time period; a universally unique identifier (“UUID”) generated by the Family Storage Vault 220; or other data to identify a Family with certainty in relation to other Families.

A Family may include two or more Defined Family Relationships 222-224 and/or one or more Children 221A-C to 223A-C with a defined relationship indicating how two or more Defined Family Relationships 222-224 and/or Children 221A-C to 223A-C relate to each other. Relationship may include, by way of non-limiting example: a biological parent child relationship; a legal parent child relationship; a biological sibling relationship; a legal sibling relationship; any parent child multi-generational relationship; a biological extended family relationship, including aunts, uncle sand cousins; a legal extended family relationship, including aunts, uncles and cousins; a domestic partnership; extended family relationship with a nexus in a domestic partnership; a common law marriage relationship; a legal guardianship; or other defined hierarchical and legal or biological relationship.

A Family Storage Vault 220 may receive data provided by one or more Defined Family Relationships 222-224 by way of digital transmission over the communication network or by scanning physical documents submitted to the Family Storage Vault 220. The Family Storage Vault 220 may also receive data to be stored via an Outside Submitting Agent 227 who acts on behalf of a Family Member. The Outside Submitting Agent 227 may include, for example: an attorney, an accountant, a government agent, a proxy, a medical professional business partner or administrator, or other professional, or any person with a Defined Family Relationship, engaged by or otherwise acting on behalf of or at the request of a Family Member. The Family Storage Vault 220 may thereby allocate rights at the request of one or more Family members that are not within the scope of traditional security enablements, but are specifically allocated according to the needs or request of a Family Member.

In another aspect, a Family Storage Vault 220 may receive data from a third party 228 with only a minor relationship to the Family Member. A Third Party 228, may include, for example: a vendor submitting a receipt; an employer; an educational institution; HOA; or other entity that has been supplied with a destination addressable via the communications network. A destination may include, for example: an Internet Protocol address, an email address, a uniform resource locater (“URL”), a fax number, a telephone number, or other electronic destination.

In some specific embodiments, documents may be submitted for storage via a hard copy postal address or street address, wherein the postal address is associated with a particular Family Storage Vault 220 and following delivery of the time to be stored, a digital image memorializing the document is crated and stored in the Family Storage Vault 220.

Referring now to FIG. 2B, a network illustrates some implementations of the present invention. As illustrated, a Family Storage Vault 220 system 200 may include databases, and computer servers to interface with the outside world via one or more servers. The Family Storage Vault 220 system 200 may be protected by firewalls and include image files, databases and data files. The Family Storage Vault 220 system 200 may connect to external entities 201-205 209-214 via one or more communication networks, such as the Internet, the World Wide Web, virtual private networks, cellular networks, telephonic networks or other communication network capable of transmitting and receiving digital information.

In one aspect, a user 201 may directly transmit data to the Family Storage Vault 200 for proper archiving and storage and retrieval. In another aspect, a server, such as a quality assurance server 202 may provide authentication services and certify the authenticity of a data submission to the Family Storage Vault 200. Authentication may include for example, a government certification that an official document is a certified document. For example, a copy of a birth certificate, a passport, a driver's license, a tax return, a patent or other government or quasi-government document. Similarly, an authentication server 215 may be associated with a non-governmental entity, such as a bank, a medical office, an insurance company, a work of art producer or expert, or other non-official office. For example, an insurance office may issue an authenticated copy of an insurance policy, a medical office may authenticate medical records, and a producer of works of art, or an art appraiser may certify that a piece of art is what it is represented to be. Other embodiments of a document image associated with a registered authorization and a link may accompany delivery of a document to a Family Storage Vault.

In another aspect, small database generators of documents to be archived in a Family Storage Vault 200 may include resellers or niche offers. In today's world, a user may be bombarded with an almost constant stream of advertisements, special offers, updates, alerts and other electronic communications. According to one aspect of the present invention, such communications may be received and stored by a Family Storage Vault 200 and accessed by one or more Family Members or other users.

Similarly, partner database servers 204 may supply to a Family Storage Vault 200, larger amounts of data that may be received by the Family Storage Vault 200 and stored in appropriate electronic receptacles. Partner database servers may include contracted services, social media, organizations with which a Family member is associated, of other beneficial service.

At 205, government related servers 205 may also provide information to a Family Storage Vault 200. The government server 205 may transmit official documentation, or generalized information. The Family Storage Vault 200 may receive and organize the information provided by the government server and store it for access by one or more Family Members. By way of non-limiting example, a Family member may receive government information related to Social Security into the Family Storage Vault 200. The Family Storage Vault 200 will store the government information in a secure storage allocated to such documents. A Child of the Family Member may also be granted access to the Family Storage Vault 200 storage for the Family Member based upon the Child's relationship with the Family Member. In some embodiments an Authentication Server 202 may also provide a certification or other authentication of the Social Security documents.

Delivery of documents to the Family Storage Vault 200 may be accomplished via a communications network 206-207 capable of transmitting digital data, or via a telephone network, data line, cellular network or other electronic communications medium. Specific embodiment may include a mobile network access device 210 capable of communicating via a cellular network or via IP Protocol.

By way of non-limiting example, various embodiments may include communication with a Family Storage Vault 200 originating from a network access device including a workstation at a place of employment 209. A user may access as a Family Member or as a third party submitting a document to a storage associated with a Family Member. A Family Member or third party may also access via a mobile network, such as a cellular or WiFi network from any location serviceable via the network. Similarly, a Family Member or Third Party may access Family Storage Vault 200 from a home location 211 and conduct one or more of: manage a family account; supply documents to be stored; provide access permissions for other family members, add nee family members and retrieve stored documents.

Outside commercial interests that may also provide documentation and/or receive data from the Family Storage Vault 200 may include merchants 212, strategic partners 213 and partners engaged on a limited basis 214.

In some embodiments, a first partner, such as a bank or other financial institution may provide an authenticated payment device, such as a number, a hash, an alphanumeric value, or an image to a Family Storage Vault 200 and a vendor may be provided access to the payment device in order to consummate payment or other transaction. In some preferred embodiments, the payment device may be updated on a regular basis in order to minimize any instances of fraud.

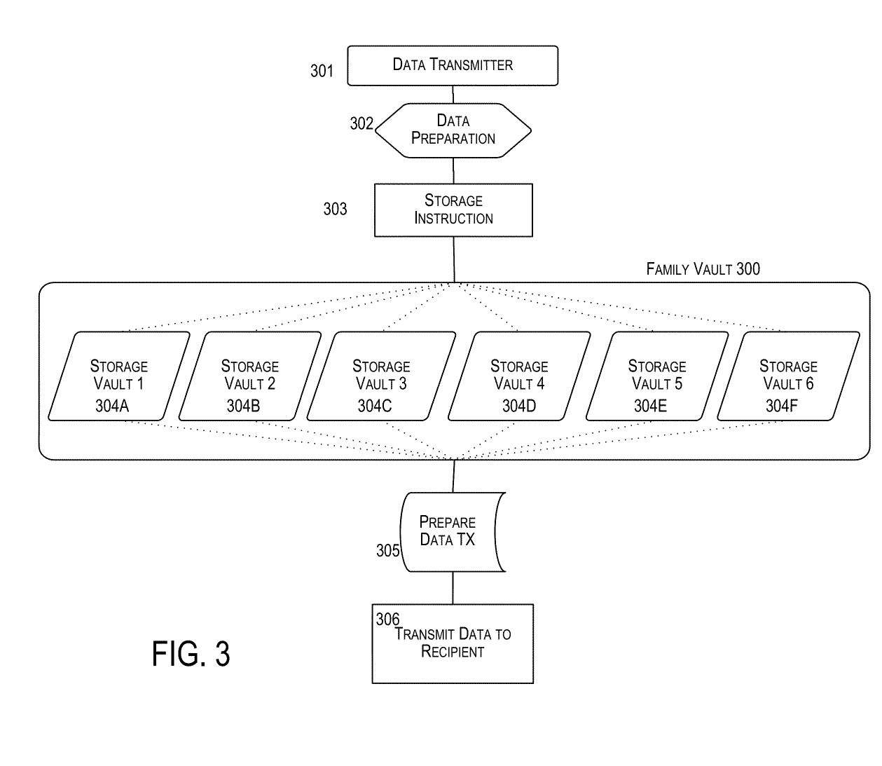

Referring now to FIG. 3, a block diagram illustrates entities and actions involved in some implementations of the present invention. A Data transmitter 301 may prepare data to be transmitted 302 and also provide a storage instruction. The storage instruction may include, for example, one or more of: a selected storage vault 304A-F to place prepared data into; which Family Members including which members with Defined Family Relationships are granted permissions to stored data and the extent of the permissions; any third parties that may have access to the stored data; how long the stored data should be stored, and any special request for the stored data.

A Family Storage Vault 220 300 may also be operative to prepare data for transmission 305 to a Family Member or a designate of the Family member. Preparation may be in response to a specific request or instruction received via the communications network. For example, Family member may transmit an instruction to access a particular storage medium in a Family Storage Vault and obtain one or more specified documents or other stored artifacts and package the specified documents and artifacts into a transmission to be delivered to a specific address for receipt by the designated recipient. The Family Storage Vault may also be operative to transmit specified documents and artifacts to a specified recipient 306. Preparation of data packages may include compressed, or zipped files, encryption, password protection or other preparation of a virtual “package” of data. Preparation of data for transmission 305 and transmission of data 306 may be in response of a user request for data, or according to preprogrammed instructions to periodically transmit data or to transmit data based upon one or more conditions being met.

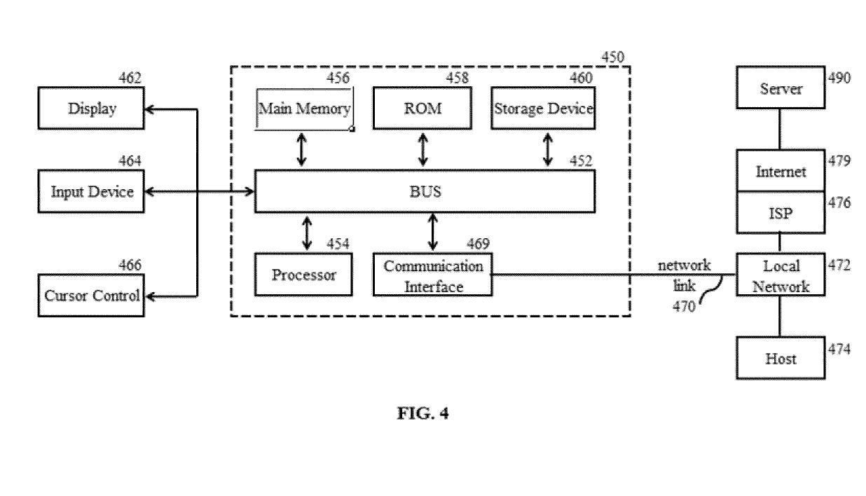

Referring now to FIG. 4, additional aspects of controller hardware which may be embodied as a smart phone, tablet, PC, laptop, a computer server, a tablet device, an electronic reader device or other programmable digital device, or other network access device useful for implementing the present invention are illustrated as a block diagram that includes a controller 450 upon which an embodiment of the invention may be implemented.

The controller 400 comprises a processor unit 410, which may include one or more processors, coupled to a communication device 420 configured to communicate via a communication network, such as the Internet, or a cellular based network such as a 3G or 4G network (not shown in FIG. 4).

The processor 410 is also in communication with a storage device 430. The storage device 430 may comprise any appropriate information storage device, including combinations of electronic storage devices, such as, for example, one or more of: hard disk drives, optical storage devices, and semiconductor memory devices such as Random Access Memory (RAM) devices and Read Only Memory (ROM) devices.

The storage device 430 can store a program 440 for controlling the processor 410. The processor 410 performs instructions of the program 440, and thereby operates in accordance with the present disclosure. The processor 410 may also cause the communication device 420 to transmit information, including, in some instances, control commands to operate apparatus to implement the processes described above. The storage device 430 can additionally store related data in a database 430A and database 430B, as needed.

As described herein, the present disclosure includes automated apparatus and methods for providing a receptacle for Family related documents and information controlling access to the stored information. In some embodiments, the apparatus and methods utilize metadata to control and manage information contained in the various databases. As used herein metadata generally includes a relatively smaller amount of data applies mainly to electronically archived or presented data and may be used in relation to the a) definition, b) structure and c) administration of data files with contents in context to facilitate the use of the captured and archived data for further use. In the present disclosure, metadata may be used to control or describe which data is viewable, to which users and administrators, for what period of time and other controlling or limiting factors.

Metadata may be created and managed for each entry included in a Family Vault database. In some embodiments, a Family Vault server may add metadata tags to data that is accessed by Family Members so that a data origination source may be determined and a data recipient may be determined. In some embodiments, the Family Vault server may create and maintain an audit trail of usage based on metadata links and make such audit trail available to an authorized Family Member, Surrogate, or other user.

Metadata may be expressed in grammatical terms; that is with a descriptive structure. Noun objects may be gateway addresses that are available and accessible, data elements that are sharable, or data for which access is forbidden. Verb actions may describe how these noun objects are processed; that is how they are operated upon. Finally adjective and adverb objects may be used to refine what is shared and how it is shared including security control. In different embodiments, the metadata sentence structure might contain gateway names, IP addresses, ownership rights, granted permission types, data specifications (type, content, source, etc.), expiration dates or other descriptive information that describes the data to which the metadata is applied.

In some embodiments, communication over a communications network may be secured via encryption. As used herein, a secure communication may include an encryption algorithm to achieve a secure transmission over the communications network. Methods such as SSL and TSL may be used form transmissions to and from a Family Vault. In some embodiments, additional security may be implemented via hardware encryption and recognition software. An example is the security protocols available as part of the Internet Protocol Version 6 IPv6 standard. Using the features of the IPv6 standard, or the like, one can ensure that the hardware at the designated IP address is known and trusted for secure communication. Using what is referred to as tunneling mode, the hardware component of the communication may implement security features that include an electronic handshake verification process and an additional hardware layer of encryption of the communicated information.

A controller may be a programmable board such as an arduino board, and/or one or more of: personal computers, laptops, pad devices, mobile phone devices and workstations located locally or at remote locations, but in communication with the Family Storage Vault. System apparatus can include digital electronic circuitry included within computer hardware, firmware, software, or in combinations thereof. Additionally, aspects of the invention can be implemented manually.

Apparatus of the invention can be implemented in a computer program product tangibly embodied in a machine-readable storage device for execution by a programmable processor and method actions can be performed by a programmable processor executing a program of instructions to perform functions of the invention by operating on input data and generating output. The present invention may be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired, and in any case, the language can be a compiled or interpreted language. Suitable processors include, by way of example, both general and special purpose microprocessors.

Generally, a processor will receive instructions and data from a read-only memory and/or a random access memory. Generally, a computer will include one or more mass storage devices for storing data files; such devices include magnetic disks, such as internal hard disks and removable disks magneto-optical disks and optical disks. Storage devices suitable for tangibly embodying computer program instructions and data include all forms of non-volatile memory, including, by way of example, semiconductor memory devices, such as EPROM, EEPROM, and flash memory devices; magnetic disks such as, internal hard disks and removable disks; magneto-optical disks; and CD ROM disks. Any of the foregoing can be supplemented by, or incorporated in, ASICs (application-specific integrated circuits).

In some embodiments, implementation of the features of the present invention is accomplished via digital computer utilizing uniquely defined controlling logic, wherein the controller includes an integrated network between and among the various participants in Process Instruments.

The specific hardware configuration used is not particularly critical, as long as the processing power is adequate in terms of application memory, network bandwidth, security and long term storage. Any number of commercially available database engines may allow for substantial account coverage and expansion. The controlling logic may use a language and compiler consistent with that on a CPU included in the Family Storage Vault. These selections will be set according to per se well-known conventions in the software community.

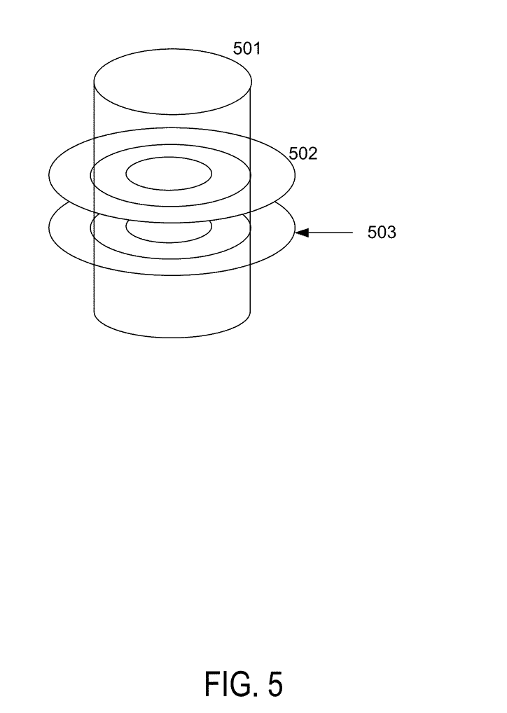

Referring now to FIG. 5, examples of physical assets that include digital storage devices are illustrated. Generally physical assets may include fungible assets such as storage mediums for storing digital data and a Purchase/Investor receives an ownership share in an aggregate of the mutual assets. However, according to some variations of the present invention, an ownership interest in one or more digital storage devices may be allocated to an Investor/Purchaser as a Family Storage Vault. The one or more digital storage devices may be in logical communication with a processor and executable software that allows the digital storage device to support email service and file storage services. As illustrated, the digital storage device may include allocable assets such as one or more partitions 501 of a hard drive and may also include contiguous cylinders 502 or disparate cylinders. Hard drives are well known in the art and software and mechanisms to divide a hard drive are also known. Definitions may be stored, for example in a File allocation Table or “FAT”. Embodiments may also include one or more hard drives being allocated to a Family Storage Vault. Additional embodiments may include allocation of portions of a solid state drive 503 or one or more entire SSDs dedicated to a Family Storage Vault.

### CONCLUSION

A number of embodiments of the present invention have been described. While this specification contains many specific implementation details, there should not be construed as limitations on the scope of any inventions or of what may be claimed, but rather as descriptions of features specific to particular embodiments of the present invention.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. In certain implementations, multitasking and parallel processing may be advantageous. Nevertheless, it will be understood that various modifications may be made without departing from the spirit and scope of the claimed invention.

What is claimed is:

1) An apparatus for allocating assets of a Family Storage Vault the apparatus comprising:
a Mutual Company owned storage medium for storing digital data, said storage medium comprising allocable portions and said storage medium in logical communication with a computer server accessible with a network access device via a digital communication network; and
executable software stored on the server and executable on demand via the network access device, the software operative with the server to cause the server to:
receive data descriptive of a First Entity Unit Member making an investment in an Entity Unit Storage Vault Mutual Company;
define an Entity Unit comprising a Head of Household and multiple persons named as Family Members and store parameters of the Family Unit on the server;
generate an Entity Unit Storage Vault associated with the Family Unit;
allocate an ownership interest in mutual assets to the Entity Unit Storage Vault; and
provide automated services providing email and file storage functionality to the Entity Unit Member.

2) The apparatus of claim 1 wherein the software is additionally operative to define a Family Unit comprising a Head of Household and multiple persons named as Family Members and store parameters of the Entity Unit on the server.

3) The apparatus of claim 2 wherein the software is additionally operative to define a relationship between the Entity Unit members and the head of Household.

4) The apparatus of claim 1 wherein the software is additionally operative with the server to provide management authority to the Head of Household over the Family Account.

5) The apparatus of claim 4 wherein the software is additionally operative with the server to provide management authority to the Head of Household over Family Member accounts.

6) The apparatus of claim 1 wherein the Entity Unit Storage Vault is associated with a single Entity Unit and accessible only to Entity Unit Members.

7) The apparatus of claim 1 wherein the software is additionally operative with the server to allocate one or more allocable portions of the storage medium to the Entity Unit as an Entity Unit Storage Vault.

8) The apparatus of claim 7 wherein the allocable portions of the storage medium comprising the Entity Unit Storage Vault comprises a designation of one or more partitions of a hard drive.

9) The apparatus of claim 7 wherein the allocable portions of the storage medium comprising the Entity Unit Storage Vault comprises an entire hard drive.

10) The apparatus of claim 7 wherein the allocable portions of the storage medium comprising the Entity Unit Storage Vault comprises a designation of one or more portions of a solid state drive.

11) The apparatus of claim 7 wherein the allocable portions of the storage medium comprising the Entity Unit Storage Vault comprises an entire Solid State Drive.

12) The apparatus of claim 1 wherein digital communication network comprises the Internet.

13) The apparatus of claim 1 wherein the software is additionally operative with the server to add metadata tags to data that is accessed by Entity Unit Members so that a data origination source may be determined.

14) The apparatus of claim 1 wherein the software is additionally operative with the server to add metadata tags to data that is accessed by Entity Unit Members so that a data recipient may be tracked.

15) The apparatus of claim 1 wherein the software is additionally operative with the server to store Defined Family Relationships between Entity Unit Members.
